(19) United States
(12) Patent Application Publication
(10) Pub. No.: US 2018/0143655 A1
(43) Pub. Date: May 24, 2018

(54) ELECTRONIC DEVICE, CONTROL METHOD FOR ELECTRONIC DEVICE, AND PROGRAM

(71) Applicant: KYOCERA Corporation, Kyoto-shi (JP)

(72) Inventor: Gen MATSUI, Yokohama-shi (JP)

(21) Appl. No.: 15/817,314

(22) Filed: Nov. 20, 2017

(30) Foreign Application Priority Data
Nov. 21, 2016 (JP) 2016-225799

(51) Int. Cl. G05D 23/19; G05B 15/02

(52) U.S. Cl. CPC G05D 23/1928; G05B 15/02

(57) ABSTRACT

The electronic device includes a temperature sensor and a controller. The controller acquires temperature detected by the temperature sensor when transitioning to the predetermined mode. When the temperature is equal to or higher than a temperature judgment value, the controller performs a plurality of functions corresponding to the predetermined mode. When the temperature is lower than the temperature judgment value, the controller performs a subset of the plurality of functions.

### CROSS REFERENCE TO RELATED APPLICATION

This application claims priority to and the benefit of Japanese Patent Application No. 2016-225799 filed on Nov. 21, 2016, the entire contents of which are incorporated herein by reference.

### TECHNICAL FIELD

This disclosure relates to an electronic device, a control method for the electronic device, and a program.

### BACKGROUND

Electronic devices which have a plurality of security functions are known.

### SUMMARY

An electronic device according to one embodiment of the disclosure includes a temperature sensor and a controller. The controller is configured to acquire a temperature detected by the temperature sensor when transitioning to a predetermined mode. When the temperature is equal to or higher than a temperature judgement value, the controller performs a plurality of functions corresponding to the predetermined mode. When the temperature is lower than the temperature judgement value, the controller performs a subset of the plurality of functions.

A control method of an electronic device according to one embodiment of the disclosure acquires a temperature detected by a temperature sensor when transitioning to a predetermined mode. When the temperature is equal to or higher than a temperature judgement value, the controller performs a plurality of functions corresponding to the predetermined mode. When the temperature is lower than the temperature judgement value, the controller performs a subset of the plurality of functions.

A non-transient computer readable storage medium which stores program instructions which, when executed by an electronic device, cause the electronic device to acquire a temperature detected by the temperature sensor when transitioning to a predetermined mode. When the temperature is equal to or higher than a temperature judgement value, the program causes the electronic device to perform a plurality of functions corresponding to the predetermined mode. When the temperature is lower than the temperature judgement value, the program causes the electronic device to perform a subset of the plurality of functions.

### BRIEF DESCRIPTION OF THE DRAWINGS

In the accompanying drawings:

FIG. 1 is a diagram illustrating a summary of a network to which an electronic device according to an embodiment is connected.

FIG. 2 is a functional block diagram illustrating an example of a schematic configuration of the electronic device according to an embodiment.

FIG. 3 is a flowchart illustrating an example of control performed by the electronic device.

FIG. 4 is a flowchart illustrating an example of control performed when battery temperature is equal to or higher than a judgment value.

FIG. 5 is a flowchart illustrating an example of control performed when the battery temperature is lower than the judgment value.

### DETAILED DESCRIPTION

In a predetermined mode, an electronic device may perform a plurality of functions corresponding to the predetermined mode. In some states, there is a risk that the electronic device may only be able to perform some of the plurality of functions. It is therefore desired that the more important functions among the plurality of functions are performed.

Accounting for the above points, this disclosure seeks to provide an electronic device, a control method for the electronic device, and a program capable of performing the more important functions among a plurality of functions in the predetermined mode.

An electronic device according to an embodiment may be a mobile electronic device such as a mobile phone or a smartphone. The electronic device according to the present embodiment is not limited to a mobile electronic device. The electronic device may be a desktop PC (Personal Computer), a laptop PC, a tablet PC, a household appliance, an industrial device or an FA (Factory Automation) device, a specialized terminal, and so on.

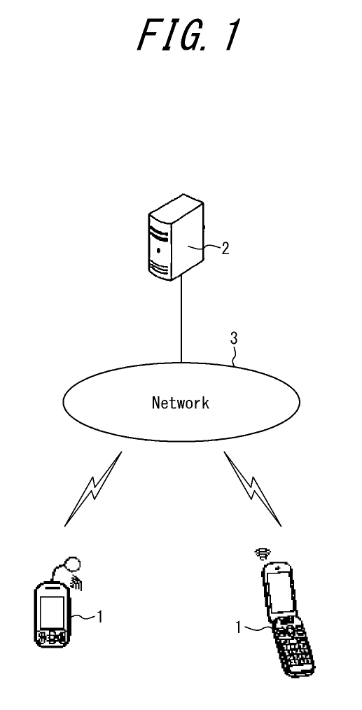

As illustrated in FIG. 1, an electronic device 1 according to the embodiment is communicably connected to a network 3. The network 3 may be the Internet, an intranet, or the like. The network 3 may be a cellular communication network or the like. A server 2 may be connected to the network 3. The server 2 is capable of transmitting and receiving data to and from the electronic device 1.

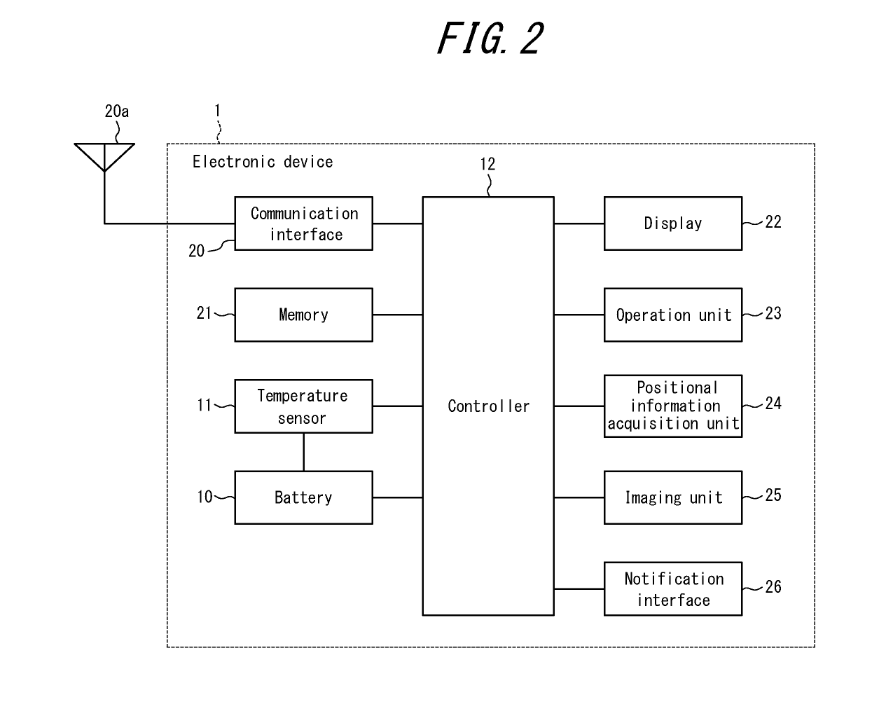

As illustrated in FIG. 2, the electronic device 1 according to the embodiment includes a battery 10, a temperature sensor 11, and a controller 12. The electronic device 1 further includes a communication interface 20, a memory 21, a display 22, an operation unit 23, a positional information acquisition unit 24, an imaging unit 25, and a notification interface 26.

The battery 10 supplies power to components of the electronic device 1. The battery 10 may be a primary cell such as a dry cell or a button cell. The battery 10 may be a secondary cell such as a nickel hydrogen cell or a lithium ion cell. The battery 10 is not limited to such cells and may be any battery. Performance of the battery 10 may be evaluated on the basis of, for example, a total amount of charge that may be output from the battery 10. The total amount of charge that may be output from the battery 10 is also referred to as remaining battery charge. The performance of the battery 10 may be evaluated based on maximum current that may be output from the battery 10. The maximum current that may be output from the battery 10 is also referred to as a battery output. When the battery 10 includes electrodes and electrolyte, the battery output may become lower as the temperature of the electrolyte becomes lower. A relation between the temperature of the electrolyte and the battery output differs depending on the type of the battery 10.

The temperature sensor 11 detects temperature in the vicinity of, on a surface of, or inside the battery 10. The temperature in the vicinity of, on the surface of, or inside the battery 10 correlates with the temperature of the electrolyte contained in the battery 10. A relationship between the temperature detected by the temperature sensor 11 and the temperature of the electrolyte can differ depending on the type of the battery 10 or a location of the temperature sensor 11. The temperature sensor 11 may be any sensor, including a thermocouple, a resistance temperature detector, or a thermistor. The temperature sensor 11 may be disposed inside a housing of the electronic device 1. The temperature sensor 11 may be disposed on a substrate near the battery 10. The temperature sensor 11 may be adhered to the surface of the battery 10. The temperature sensor 11 may be incorporated in the battery 10.

The controller 12 controls operations of the components of the electronic device 1 and causes the components to perform various functions. The controller 12 acquires the temperature detected by the temperature sensor 11. The controller 12 may acquire the remaining battery charge from the battery 10. The controller 12 may acquire a terminal voltage of the battery 10 and calculate the remaining battery charge based on the terminal voltage. The controller 12 may acquire the battery output. The controller 12 may acquire the battery output from the battery 10. The controller 12 may acquire the type of the battery 10 and calculate the battery output based on the type of the battery 10. The controller 12 may calculate the battery output based on the temperature detected by the temperature sensor 11 and the terminal voltage. The controller 12 may store, in the memory 21, various information including the remaining battery charge or the battery output, or a program and so on that are used to operate the components of the electronic device 1.

When the remaining battery charge becomes lower than a charging lower limit, the controller 12 forcibly shuts down the electronic device 1 to prevent overdischarge of the battery 10. The charging lower limit is set according to the type of the battery 10. Monitoring of the remaining battery charge and shutting down of the electronic device 1 in accordance with the remaining battery charge is performed by the controller 12 independently of controlling the operations of the components. Thus, the controller 12 shuts down the electronic device 1 and stops power supply from the battery 10 regardless of the operating states of the components.

The controller 12 is configured with, for example, a processor. The controller 12 may include at least one processor. The processor may include a general-purpose processor configured to load a specific program and to perform a specific function, or a specialized processor dedicated to a specific operation. Such a specialized processor may include an application specific IC. The application specific IC is also referred to as ASIC (Application Specific Integrated Circuit). The processor may include a programmable logic device. The programmable logic device is also referred to as PLD (Programmable Logic Device). The PLD may include FPGA (Field-Programmable Gate Array). The controller 12 may be either SoC (System-on-a-Chip) having one or more processors cooperating with one another, or SiP (System In a Package).

The communication interface 20 is connected to the network 3 via an antenna 20a and communicates with the network 3 using cellular communications or wireless communications, such as over a wireless LAN (Local Area Network). The communication interface 20 may include a modem or a wireless LAN device. The communication interface 20 may be configured to communicate with another device without using the network 3. The communication interface 20 is connected to the controller 12 and acquires, from the controller 12, data to be output to the network. The communication interface 20 outputs data received from the network to the controller 12.

The memory 21 may be configured with, for example, a semiconductor memory. The memory 21 may function as a work memory of the controller 12. The memory 21 may be included in the controller 12.

The display 22 displays characters, images, operation objects, pointers, and so on, based on information obtained from the controller 12. The display 22 may be a display device such as, but not limited to, a liquid crystal display, an organic EL (Electroluminescence) display, or an inorganic EL display.

The operation unit 23 receives an input operation from a user of the electronic device 1. The operation unit 23 may, for example, be configured as a physical key such as a numeric keypad, a touch pad, or a touch panel. When the operation unit 23 is configured as a touch panel, the operation unit 23 may be integrally formed with the display 22. The controller 12, based on input content acquired from the operation unit 23, may move a pointer or the like displayed in the display 22, or select an operation object. The operation unit 23 may include a strap. The operation unit 23 may receive an input operation in response to the user pulling the strap. The operation unit 23 may include a sliding switch. The operation unit 23 may receive an input operation in response to the user sliding the sliding switch.

The positional information acquisition unit 24 acquires positional information indicating the position of the electronic device 1. The positional information acquisition unit 24 may be a device configured to locate the electronic device 1 on the basis of information from a satellite positioning system such as GPS (Global Positioning System) or GLONASS (Global Navigation Satellite System). The positional information acquisition unit 24 may be a device configured to locate the electronic device 1 on the basis of radio waves associated with cellular communication or a wireless LAN. The positional information acquisition unit 24 may be a device configured to locate the electronic device 1 based on information provided by an acceleration sensor and so on. The positional information acquisition unit 24 is not limited to the above devices but may be a device configured to locate the electronic device 1 by employing other methods.

The imaging unit 25 captures an image in the vicinity of the electronic device 1 and thus acquires a captured image. The imaging unit 25 may capture an image of landscape surrounding the electronic device 1. The imaging unit 25 may capture an image of a person holding the electronic device 1 or a person near the electronic device 1. The imaging unit 25 may be attached to the electronic device 1 in such a manner as to be able to capture an image in various directions including a front direction, a rear direction, and side directions from the electronic device 1. The front direction from the electronic device 1 may be a direction in which the electronic device 1 is facing the user in normal use. The rear direction from the electronic device 1 is a direction opposite to the front direction. The side directions from the electronic device 1 are different from the front direction and the rear direction. The imaging unit 25 may include a solid state image sensor. The solid state image sensor may be a CCD (Charge-Coupled Device) image sensor or a CMOS (Complementary Metal Oxide Semiconductor) image sensor. The solid state image sensor is not limited thereto but may be any other sensor.

The notification interface 26 notifies of a state of the electronic device 1 to its surroundings. The notification interface 26 may have a light source such as LED (Light Emission Diode) or a halogen lamp. The notification interface 26 may notify of the state of the electronic device 1 to its surroundings by lighting or flashing the light source. The notification interface 26 may, for example, include a buzzer, such as a piezoelectric buzzer or an electromagnetic buzzer, or a speaker to generate a predetermined sound. The notification interface 26 may notify of the state of the electronic device 1 to its surroundings by sounding the buzzer or generating a sound.

The controller 12 acquires information indicating power consumption of each component. The controller 12 may preliminarily acquire the information indicating power consumption from each component and store the information in the memory 21. The controller 12 may sequentially acquire the information indicating power consumption from each component. The controller 12 may acquire the power consumption of each function performed by each component. For example, the controller 12 may acquire power consumption corresponding to a captured image from the imaging unit 25. The controller 12 may acquire power consumption corresponding to performed notification means from the notification interface 26. The controller 12 may acquire, in a table form, the information indicating power consumption of each component or the power consumption of each function performed by each component. The controller 12 may calculate the power consumption of each function performed by each component using a predetermined formula.

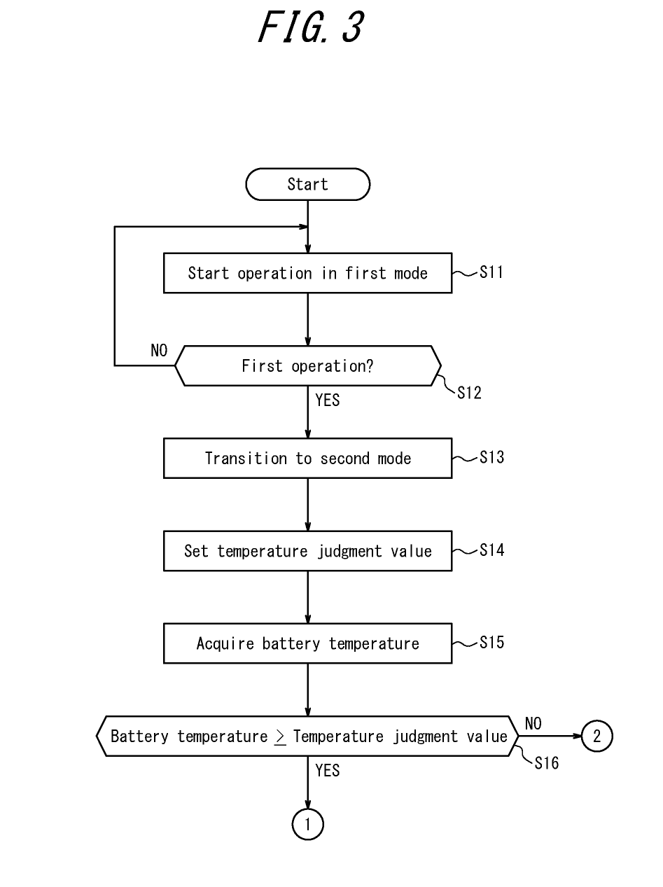

The electronic device 1 according to the present embodiment may operate a control method in accordance with a procedure of flowcharts illustrated in FIGS. 3 to 5, for example.

The controller 12 operates in a first mode (step S11). The first mode may be a mode for normal use of the electronic device 1 by the user.

The controller 12 acquires information indicating an input operation performed by the user from the operation unit 23. The controller 12 determines whether the user has performed a first operation (step S12). The first operation may be, for example, an operation to press down a predetermined key of the operation unit 23 or an operation to press and hold the key for at least a predetermined time period. The first operation may be an operation performed on the touch panel or the touch pad of the operation unit 23 to touch a predetermined position or to slide in a predetermined direction. The first operation may be an operation to pull the strap of the operation unit 23. The first operation may be an operation to slide the sliding switch of the operation unit 23. The first operation is not limited to the above operations but may be a combination of a plurality of operations or any other operation. The first operation may be, for example, an operation to press down the predetermined key and then touch a confirmation screen displayed on the touch panel of the display 22. The predetermined key of the operation unit 23 may be configured to require more force to be pushed down, as compared with other keys.

When the first operation is not performed (step S12: NO), the controller 12 continues the procedure at step S12. When the first operation is performed (step S12: YES), the controller 12 transitions to a second mode (step S13). The second mode may be a mode in which the electronic device 1 is used by the user for a purpose that is different from normal use. The second mode may also be referred to as a predetermined mode. The controller 12, when having transitioned to the second mode, performs a function corresponding to the second mode. The function corresponding to the second mode may include a plurality of functions.

According to the present embodiment, the second mode is assumed to be a mode corresponding to the user being in an emergency situation, wherein the emergency situation is to be notified to the user's surroundings or to the server 2, via the network 3. The mode corresponding to the user being in an emergency situation is also referred to as an emergency mode. The second mode is not limited to the above modes and may be a mode which limits operations by the user or a mode which autonomously records actions of the user. The second mode may be any other mode.

The controller 12 sets a temperature judgment value used for judging the temperature detected by the temperature sensor 11 (step S14). The temperature judgment value may be set based on the remaining battery charge. The temperature judgment value may be set based on the battery output. The temperature judgment value may be set based on the information indicating the power consumed by each component of the electronic device 1 to perform respective functions as controlled by the controller 12. The temperature judgment value may be set based on at least one of the remaining charge of the battery 10, the current that can be output by the battery 10, and the information indicating the power consumption of the electronic device 1. The controller 12 may set the temperature judgment value based on a table indicating a relation between the temperature judgment value and at least one of the remaining charge of the battery 10, the current that can be output by the battery 10, and the information indicating the power consumption of the electronic device 1. The temperature judgment value may be set based on any other information.

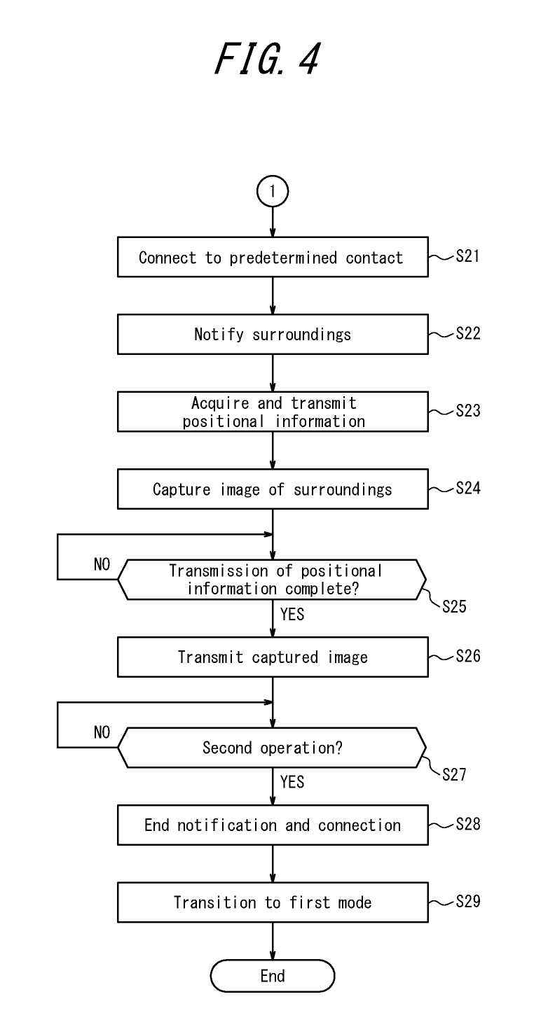

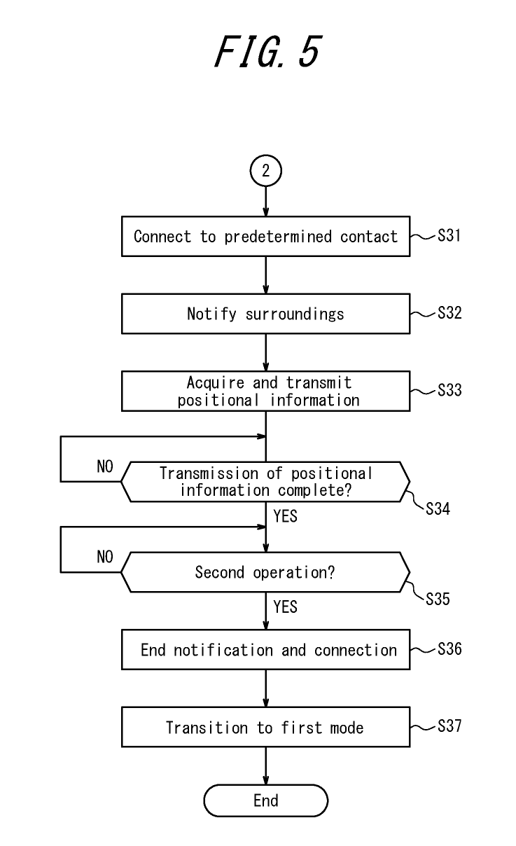

The controller 12 acquires the temperature detected by the temperature sensor 11 (step S15). The temperature detected by the temperature sensor 11 may also be referred to as the battery temperature. The controller 12 determines whether the battery temperature is lower than the temperature judgment value (step S16). When the battery temperature is equal to or higher than the temperature judgment value (step S16: YES), the controller 12 proceeds to step S21 of FIG. 4. When the battery temperature is lower than the temperature judgment value (step S16: NO), the controller 12 proceeds to step S31 of FIG. 5.

Battery Temperature Equal to or Higher than Temperature Judgment Value

The controller 12 connects the communication interface 20 to a predetermined contact (step S21). The predetermined contact may include, for example, a family member of the user of the electronic device 1, a work place or any other party or acquaintance related to the user. The predetermined contact may include the server 2. The communication interface 20 may connect to the predetermined contact via the network 3. The communication interface 20 may connect to the predetermined contact without using the network 3. When the predetermined contact has a voice call function, the communication interface 20 may make a voice call to the predetermined contact. When connected to the predetermined contact, the user may easily notify the predetermined contact that an operation mode of the controller 12 has transitioned to the second mode. The controller 12 may autonomously notify the predetermined contact that the operation mode of the controller 12 has transitioned to the second mode. A function of the communication interface 20 to notify the predetermined contact of the transition of the operation mode is also referred to as a mode transition notification function. The mode transition notification function may be included in the functions corresponding to the second mode. The mode transition notification function enables the user to reliably notify the predetermined contact that the operation mode of the controller 12 has transitioned to the second mode.

The controller 12 causes the notification interface 26 to notify of the transition of the operation mode of the controller 12 to the second mode (step S22) to its surroundings. When the second mode is the emergency mode, the notification interface 26 may, for example, sound the buzzer or generate the sound from the speaker. This function, whereby the notification interface 26 sounds the buzzer or generates the sound from the speaker, is also referred to as an audio output function. The audio output function may be included in the functions corresponding to the second mode. The notification interface 26 may, for example, light up the light source or flash the light source according to a predetermined pattern. This function, whereby the notification interface 26 lights up the light source or flashes the light source in the predetermined pattern, is also referred to as a lighting function. The lighting function may be included in the functions corresponding to the second mode. The audio output function and the lighting function can effectively notify of the emergency mode of the electronic device 1 to its surroundings. The notification interface 26 may employ any other method to notify of the transition of the operation mode of the controller 12 to the second mode to its surroundings.

The controller 12 causes the positional information acquisition unit 24 to acquire the positional information for the electronic device 1 and to transmit the positional information to the communication interface 20 (step S23). The communication interface 20 may notify the predetermined contact and the like of the positional information. This function, whereby the communication interface 20 notifies the predetermined contact and the like of the positional information, is also referred to as a positional information notification function. The positional information notification function may be included in the functions corresponding to the second mode. The positional information notification function improves accessibility to the electronic device 1 or the user of the electronic device 1.

The controller 12 causes the imaging unit 25 to capture a surrounding image of the electronic device 1 (step S24). This function, whereby the imaging unit 25 captures the surrounding image, is also referred to as an imaging function. The imaging function may be included in the functions corresponding to the second mode. The controller 12 may cause the imaging unit 25 to capture an image while the positional information acquisition unit 24 is acquiring the positional information for the electronic device 1. The controller 12 may cause the imaging unit 25 to capture an image while the communication interface 20 is transmitting the positional information for the electronic device 1. The imaging unit 25 captures the surrounding image of the electronic device 1 and thus acquires the captured image. The imaging unit 25 may acquire one or more captured images. When the imaging unit 25 is capable of capturing images in a plurality of directions from the electronic device 1, the imaging unit 25 may acquire a different number of captured images in each direction. For example, the imaging unit 25 may acquire two or more captured images in the front direction from the electronic device 1 and one captured image in the rear direction from the electronic device 1. The number of captured images acquired by the imaging unit 25 is not limited thereto. The imaging function enables the predetermined contact destination and the like to easily understand the state of the surroundings of the electronic device 1 or the user of the electronic device 1. As a result, a response may be easily made to the electronic device 1 or the user of the electronic device 1.

The controller 12 determines whether the communication interface 20 has completed the transmission of the positional information (step S25). When the transmission of the positional information has not been completed (step S25: NO), the controller 12 continues the procedure of step S25.

When the transmission of the positional information has been completed (step S25: YES), the controller 12 causes the communication interface 20 to transmit the captured image (step S26). This function of transmitting the captured image may be included in the functions corresponding to the second mode. The communication interface 20 may transmit the captured image to the server 2 or the predetermine contact and the like, via the network 3.

The controller 12 acquires information indicating the input operation performed by the user from the operation unit 23. The controller 12 determines whether there is a second operation performed by the user (step S27). The second operation may be, for example, the operation to press down a predetermined key of the operation unit 23 or an operation to press and hold the key for at least the predetermined time period. The second operation may be the operation performed on the touch panel or the touch pad of the operation unit 23 to touch a predetermined position or to slide in a predetermined direction. The second operation may be an operation to restore the strap of the operation unit 23 which was been pulled as the first operation. The second operation may be an operation to restore the sliding switch of the operation unit 23 which was slid as the first operation. The second operation is not limited to the above operations but may be a combination of a plurality of operations or any other operation.

When the second operation is not detected (step S27: NO), the controller 12 continues procedure of step S27. When the second operation is detected (step S27: YES), the controller 12 ends the notification to its surrounding started at step S21 and the connection to the predetermined contact started at step S22 (step S28). The controller 12 transitions to the first mode (step S29) and ends the process illustrated in the flowchart of FIG. 4.

Battery Temperature Lower than Temperature Judgment Value

The controller 12 performs procedures at step S31, S32, and S33 of FIG. 5. The steps S31, S32, and S33 are similar to respective steps S21, S22, and S23 of FIG. 4.

When the battery temperature is lower than the temperature judgment value, the controller 12 does not perform the imaging function, unlike the step S24 of FIG. 1. Following step S33, the controller 12 performs step S34, which is similar to step S25 of FIG. 4.

Since the controller 12 does not acquire the captured image, the controller 12, unlike step S26 of FIG. 4, does not perform the function to cause the communication interface 20 to transmit the captured image. Following step S34, the controller 12 performs steps S35, S36, and S37, which are similar to respective steps S27, S28, and S29 of FIG. 4.

As described above, the electronic device 1 according to the present embodiment performs different functions depending on whether the battery temperature is equal to or higher than the temperature judgment value, or lower than the temperature judgment value. When the battery temperature is lower than the temperature judgment value, the remaining battery charge may sharply decrease. For example, the imaging function may consume a relatively large amount of electric power. When all functions corresponding to the second mode including the imaging function are performed, execution of the imaging function may sharply drain the remaining battery charge. When the remaining battery charge falls under the charging lower limit, the electronic device 1 is forcibly shut down. Forcible shut down of the electronic device 1 may cause failure to complete the imaging function or failure to perform the positional information notification function.

When the user activates the emergency mode, the positional information for the electronic device 1 may be more important for assisting or rescuing the user. In the electronic device 1 according to the present embodiment, when the battery temperature is lower than the temperature judgment value, the controller 12 is limited to performing only a subset of the functions corresponding to the second mode. For example, the controller 12 may perform a limited subset of the functions which excludes the imaging function, as illustrated in FIG. 5. By limiting to the set of functions which excludes the imaging function, the controller 12 is able to perform the positional information notification function. As a result, the more important functions among the plurality of functions can be performed.

Operation of the controller 12 is not limited to the first mode and the second mode. The controller 12, when transitioning to the second mode from another mode, performs the plurality of functions corresponding to the second mode. The controller 12, in response to the second operation, may transition from the second mode to another mode other than the first mode.

When the electronic device 1 has been shut down, or when the power of the electronic device 1 is off, the controller 12 is said to be in a shut-down mode. The controller 12, even in the shut-down mode, may start up the electronic device 1 in response to the first operation and operate in the second mode. In this case, the controller 12, although transitioning to the second mode from the shut-down mode, performs the plurality of functions corresponding to the second mode. When the controller 12 is in the shut-down mode, the first operation may be the operation to pull the strap of the operation unit 23. The first operation may be the operation to slide the sliding switch of the operation unit 23. The first operation may be the operation to press down the predetermined key of the operation unit 23 or the operation to press and hold the key for at least the predetermined time period.

A priority order is set for each of the functions corresponding to the second mode.

In some examples, the second mode is assumed to be the emergency mode. In this case, the mode transition notification function for notifying of the emergency mode to the predetermined contact destination may be given high priority. The positional information notification function for notifying of the user's current position to the predetermined contact and the like of may be given high priority. The audio output function or the lighting function for notifying of the emergency mode to the surroundings may be given high priority. The imaging function may be given relatively low priority.

In some examples, the second mode is assumed to be the mode for autonomously recording actions of the user. In this case, high priority may be assigned to the positional information notification function for notifying of the current position of the electronic device 1 to the server 2.

The power consumption of the imaging unit 25 increases in proportion to the number of captured images acquired by the imaging unit 25. The controller 12 may determine the number of captured images to be acquired by the imaging unit 25 based on the remaining battery charge or the battery output. The controller 12 may reduce the number of captured images when, for example, the remaining battery charge is low. The controller 12 may reduce the number of captured images when, for example, the battery output is low. For example, when the temperature detected by the temperature sensor 11 upon transition of the operation mode to the predetermined mode is equal to or higher than the temperature judgment value, the controller 12 may cause the imaging unit 25 to acquire a first number of captured images. For example, when the temperature detected by the temperature sensor 11 is lower than the temperature judgment value, the controller 12 may cause the imaging unit 25 to acquire a second number of captured images, which is less than the first number of captured images.

At step S23 of FIG. 4 or at step S33 of FIG. 5, there may be a case where the positional information is not acquired for at least a predetermined time period. When the positional information cannot be acquired within the predetermined time period, the controller 12 may proceed to step S26 or step S35, skipping step S25 or step S34, to determine whether the transmission of the positional information is completed.

The server 2 is assumed to be administrated by a service provider with which the user of the electronic device 1 is contracted. The services to which the user subscribes may include various services such as a crime prevention service for securing the safety of the user and a tracking service for tracking the position of the electronic device 1. The electronic device 1 according to the present embodiment may be used by a user who does not subscribe to these services.

Upon reception of the notification from the electronic device 1 that the operation mode of the controller 12 has transitioned to the second mode, the server 2 may instruct the service provider to respond in accordance with the notification. For example, when the second mode is the emergency mode, the server 2, based on, for example, the positional information for the electronic device 1, may instruct the service provider to send personnel to the current position of the electronic device 1. The server 2, based on, for example, the captured image acquired from the electronic device 1, may infer a state of the surroundings at the current position of the electronic device 1. The server 2 may instruct the service provider to respond in accordance with the state of the surroundings at the current position of the electronic device 1.

Although the disclosure has been described based on the figures and the embodiment, it is to be understood that various modifications and changes may be easily implemented based on the disclosure by those who are ordinarily skilled in the art. Accordingly, such modifications and changes are included in the scope of the disclosure. For example, functions and the like included in each component or step may be rearranged without logical inconsistency, so as to combine a plurality of components or steps together or to separate them. Although the device according to the embodiment of the disclosure has been mainly described above, the embodiment of the disclosure may also be implemented by a method including a step performed by each component of the device. It should be understood that a method or a program executed by a processor of the device according to the embodiment of the disclosure and a storage medium storing the program may also implement the embodiment of the disclosure and thus are included in the scope of the disclosure.

The “first” and the “second” used herein are identifiers used for distinguishing components. The identifiers of the components distinguished by the “first” and the “second” used herein are interchangeable. For example, between the first mode and the second mode, the identifiers “first” and the “second” are interchangeable. The interchange of the identifiers concurs with each other. After the interchange of the identifiers, the components are distinguished from each other. The identifiers may be removed. The components from which the identifiers are removed are distinguished by reference signs. Neither interpretation of orders of the components nor assumption of the presence of an identifier with a smaller number should be made simply based on the identifiers such as the “first” and the “second” used herein.

1. An electronic device comprising a temperature sensor and a controller, wherein the controller is configured to:
acquire a temperature detected by the temperature sensor when transitioning to a predetermined mode;
perform a plurality of functions corresponding to the predetermined mode when the temperature is equal to or higher than a temperature judgment value; and
perform a subset of the plurality of functions when the temperature is lower than the temperature judgment value.

2. The electronic device according to claim 1, wherein:
the plurality of functions include at least one of a mode transition notification function, a positional information notification function, an imaging function, a sound output function, and a lighting function; and
the subset of the plurality of functions includes the positional information notification function.

3. The electronic device according to claim 1, wherein the subset of the plurality of functions are determined on the basis of a priority order set for each of the plurality of functions.

4. The electronic device according to claim 2, wherein the subset of the plurality of functions are determined on the basis of a priority order set for each of the plurality of functions.

5. The electronic device according to claim 1, further comprising a battery, wherein the temperature judgment value is set on the basis of at least one of a remaining charge of the battery, an amount of current that can be output by the battery, and a power consumed when the controller performs the plurality of functions.

6. The electronic device according to claim 2, further comprising a battery, wherein the temperature judgment value is set on the basis of at least one of a remaining charge of the battery, an amount of current that can be output by the battery, and a power consumed when the controller performs the plurality of functions.

7. The electronic device according to claim 3, further comprising a battery, wherein the temperature judgment value is set on the basis of at least one of a remaining charge of the battery, an amount of current that can be output by the battery, and a power consumed when the controller performs the plurality of functions.

8. The electronic device according to claim 4, further comprising a battery, wherein the temperature judgment value is set on the basis of at least one of a remaining charge of the battery, an amount of current that can be output by the battery, and a power consumed when the controller performs the plurality of functions.

9. The electronic device according to claim 1, wherein the predetermined mode is an emergency mode.

10. The electronic device according to claim 2, wherein the predetermined mode is an emergency mode.

11. The electronic device according to claim 3, wherein the predetermined mode is an emergency mode.

12. The electronic device according to claim 25, wherein the predetermined mode is an emergency mode.

13. The electronic device according to claim 5, wherein the predetermined mode is an emergency mode.

14. The electronic device according to claim 6, wherein the predetermined mode is an emergency mode.

15. The electronic device according to claim 7, wherein the predetermined mode is an emergency mode.

16. The electronic device according to claim 8, wherein the predetermined mode is an emergency mode.

17. A control method for an electronic device, the control method comprising:
acquiring a temperature detected by a temperature sensor when transitioning to a predetermined mode;
performing a plurality of functions corresponding to the predetermined mode when the temperature is equal to or higher than a temperature judgment value; and
performing a subset of the plurality of functions when the temperature is lower than the temperature judgment value.

18. A non-transient computer readable storage medium which stores program instructions which, when executed by an electronic device, cause the electronic device to:
acquire a temperature detected by a temperature sensor when transitioning to a predetermined mode;
perform a plurality of functions corresponding to the predetermined mode when the temperature is equal to or higher than a temperature judgment value; and
perform a subset of the plurality of functions when the temperature is lower than the temperature judgment value.
